(19) United States
(12) Patent Application Publication
(10) Pub. No.: US 2012/0132085 A1
(43) Pub. Date: May 31, 2012

(54) GRILLING GRID FEATURING SMOKE-FREE GRILLING

(76) Inventor: WILLIAM HOME, Neihu (TW)

(21) Appl. No.: 12/954,922

(22) Filed: Nov. 29, 2010

(51) Int. Cl. A47J 36/00; A47J 37/07

(52) U.S. Cl. 99/444; 99/450

(57) ABSTRACT

Disclosed is a cooking grid that is positionable on a top opening of a grill. The grid includes a frame, a plurality of bars, and a shield section. The bars and the shield section are arranged inside the frame, and the bars form therebetween a plurality of openings. The shield section is arranged to correspond in position to a burner unit set up inside the grill, whereby when the cooking grid receives foodstuffs positioned thereon for grilling, the shield section provides a shielding function that prevents liquid substances of grease and juice of the grilled foodstuffs and sauce applied to the foods from dropping on the burner unit to cause flaming and smoke, and thermal energy emitting from the burner unit is directly applied to the cooking grid to thereby provide functions of health, environmental protection, and energy conservation.

### (A) TECHNICAL FIELD OF THE INVENTION

The present invention generally relates to a grilling grid of a barbecue grill, and more particularly to a grilling grid that is structured to incorporate both the structure and functionality of a protection shade arranged in a grill kettle and provides a functionality of smoke-free grilling.

### (B) DESCRIPTION OF THE PRIOR ART

Grilling or barbecue is a common activity for modern people, for it allows people to taste foodstuffs that are processed in different ways and it also serves as an easy measure for social communication.

To make barbeque, a grill is prepared. A known grill comprises a cooking grid or grilling grid positioned on a top opening of the grill. Charcoals or other suitable fuels are deposited in the grill for burning, or alternatively, a burner (such as an infrared heater) is provided. With such an arrangement, foodstuffs may be placed on the grill to be heated by the charcoal fire or the burner for cooking. However, the charcoals or burners used in the conventional grills are arranged to give off thermal radiation directly toward the grid for heating the foodstuffs placed thereon, whereby the charcoal fire or the burner directly opposes openings of the grid positioned above the charcoal fire or burner. This allows liquid substances, such as sauces and greases and juices of foodstuffs, to directly fall onto the charcoal fire or the burner, whereby a large amount of thick smoke may be generated, which may cause air pollution and contamination of the foodstuffs, and is also harmful to human bodies.

As shown in FIG. 7, a known grill 90 that uses a burner as a heat source is shown. The grill 90 has a top opening on which a cooking grid 91 is position and a protection shade 93 (such as a flame tamer) is arranged above a burner unit 92 (such as a burner) located inside the grill. With a shielding function provided by the protection shade 93, in grilling foodstuffs, liquid substances, such as grease and juice of the grilled foodstuff and sauce applied to the foods, are only allowed to drop onto the protection shade 93 and are prevented from dropping on the burner unit 92 to cause flaming or acid/alkali corrosion. The conventional grill 90 has several structural drawbacks, which will be briefly described as follows:

(1) Due to the arrangement of the protection shade 93, the thermal energy emitting from the burner unit 92 cannot be directly applied to the cooking grid 91, leading to additional consumption of thermal energy and an increase of the manufacturing cost of the grill.

(2) Although a protection shade 93 is provided to shield and thus prevent liquid substances, such as grease and juice of grilled foodstuffs and sauce applied to the foods, to directly dropping on the burner unit 92, yet the protection shade 93 itself is heated by the thermal radiation from the burner unit 92 and thus similar result of flaming and smoking may occur when the liquid substances, such as grease and juice of the grilled foodstuffs and sauce applied to the foods, fall onto the protection shade 93.

Apparently, the conventional grill does not provide a structure and a smoke-free grilling operation that are considered excellent. And, it is desired to provide a cooking grid that combines the structure and functionality of a protection shade to provide a true smoke-free grilling operation. Further, with such a cooking grid, the protection shade is no longer needed for a grill, and the structure is thus made simple.

### SUMMARY OF THE INVENTION

An objective of the present invention is to provide a cooking grid that is applicable to a grill, so as to make it no longer necessary for the grill to install a protection shade for a burner of the grill, and realizing true smoke-free grilling.

To achieve the above objective, the present invention provides a cooking grid that is positionable on a top opening of a grill. The grid comprises a frame, a plurality of bars, and a shield section. The bars and the shield section are arranged inside the frame, and the bars form therebetween a plurality of openings. The shield section is arranged to correspond in position to a burner unit set up inside the grill, whereby when the cooking grid receives foodstuffs positioned thereon for grilling, the shield section provides a shielding function that prevents liquid substances of grease and juice of the grilled foodstuffs and sauce applied to the foods from dropping on the burner unit to cause flaming and smoke, and thermal energy emitting from the burner unit is directly applied to the cooking grid to thereby provide functions of health, environmental protection, and energy conservation.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a grid according to the present invention.

FIG. 2 is a cross-sectional view showing the grid of the present invention positioned on a grill.

FIG. 3 is a perspective view showing the grid of the present invention that is turned up-side down.

FIG. 4 is a cross-sectional view showing the up-side-down grid positioned on a grill to serve as a cooking grid.

FIG. 5 is a perspective view showing a gird according to another embodiment of the present invention.

FIG. 6 is a cross-sectional showing the grid of said another embodiment the present invention positioned on a grill.

FIG. 7 is a cross-sectional showing a conventional grid positioned on a grill.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

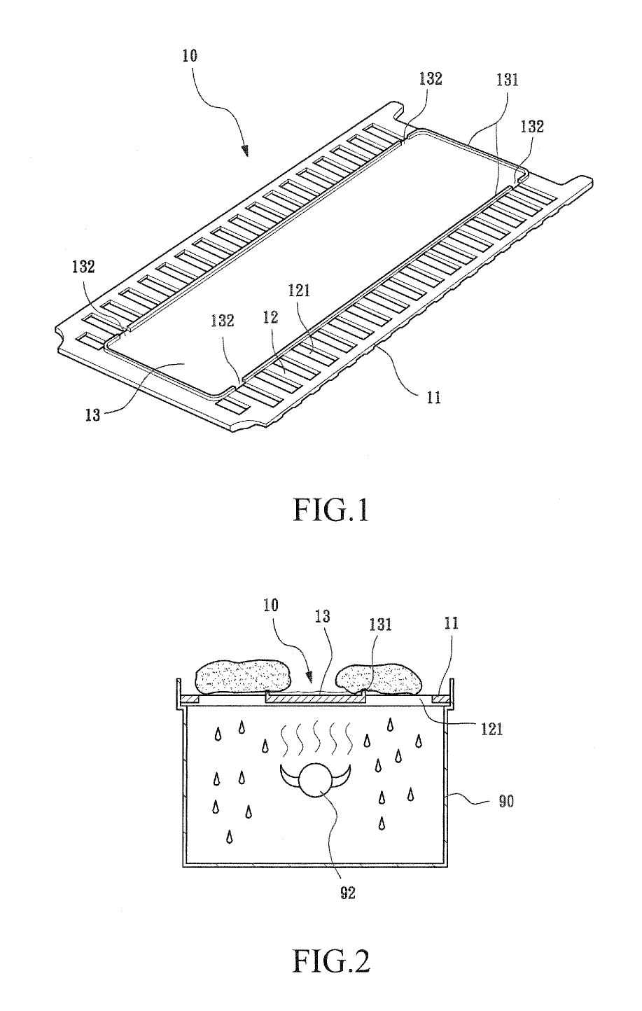

Referring to FIGS. 1 and 2, the present invention provides a cooking or grilling grid 10, which is applicable to a grill 90 to achieve smoke-free grilling and which incorporates the structure and functionality of a protection shade in order to realize smoke-free grilling for cooking food. Structurally, the grilling grid comprises a frame 11, a plurality of bars 12, and a shield section 13.

The frame 11 is shaped to mach a top opening of a grill 90 and can be for example a multi-sided configuration (but not limited to such a multi-sided configuration), to be positionable on the top opening of the grill 90.

The bars 12 and the shield section 13 are arranged inside the frame 11 for carrying and supporting foodstuffs positioned thereon. The shield section 13 is arranged at a location corresponding to a burner unit 92 that are arranged inside the grill 90. In the instant embodiment, the burner unit 92 (such as an infrared heater) of the grill 90 is arranged at a central portion, so that the shield section 13 is also set at the central portion of the cooking grid 10. The shield section 13 has a circumference on which a plurality of raised rims 131 is formed, so that the raised rims 131 of the shield section 13 delimit and define a recessed flat-bottom chamber therebetween for receiving and containing liquid substances, such as grease and juice of food and sauce applied to the food, and the liquids are constrained from random spreading. The raised rims 131 form therebetween a plurality of notches 132 through which the liquid substances of grease and juice of food and sauce may flow off. The bars 12 are distributed on opposite sides of the shield section 13 and openings 121 are formed between adjacent ones of the bars 12 to allow thermal radiation emitting from the burner unit 92 to travel through the openings 121 and also to allow the liquids draining off the notches 132 to drop down through the openings 121.

Referring to FIG. 2, an embodiment of the present invention where the cooking grid 10 serves as a grilling pan is illustrated. With the cooking grid 10 positioned on the top opening of the grill 90 to support foodstuff thereon for grilling, the shield section 13 provides a function of shielding so that liquid substances, such as grease and juice of the grilled foodstuff and sauce applied to the food, are drained through the openings 121 and fall vertically so that they do not fall on the burner unit 92 to cause undesired flame or smoke. Since no protection shade is arranged between the burner unit 92 and the cooking grid 10, the burner unit 92 may emit thermal energy that is directly applied to the cooking grid 10 to thereby provide functions of health, environmental protection, and energy conservation.

As shown, the raised rims 131 form a recessed chamber therebetween, which can function as a grilling pan or may collect liquid substances, such as grease and juice of the grilled foodstuff and sauce applied to the food, therein. Even under a condition that the grill 90 is not set on a flat surface, the raised rims 131 is also effective in preventing random flowing of liquid substances, such as grease and juice of the grilled foodstuff and sauce applied to the food, and guiding and conducting the liquid substances to flow out of the shield section through the notches 132 to subsequently drop down through the openings 121 between the bars 12.

Further, when the burner unit 92 is set up in for example a longitudinal direction, the bars 12 and the openings 121 of the cooking grid 10 of the present invention are oriented in a lateral direction with respect to the burner unit 92. This helps guiding thermal radiation from the burner unit 92 to transmit through the openings 121.

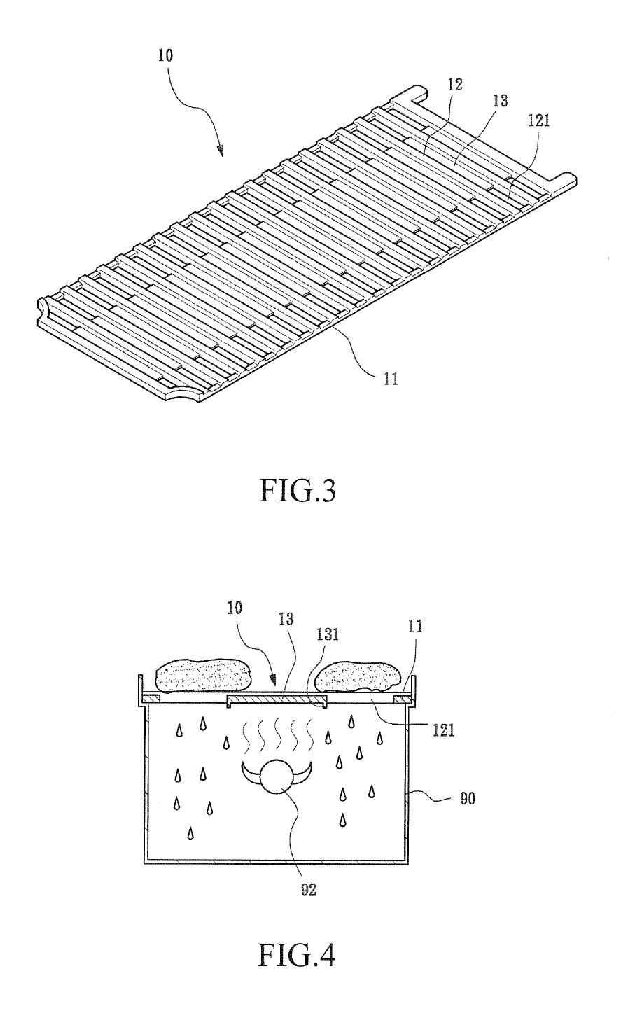

Further referring to FIGS. 3 and 4, a different way of use of the cooking grid 10 of the present invention is illustrated, where the grid 10 is turned up-side down (namely, the shield section 13 being reversed completely to have the raised rims 131 located on the underside) so that the grid may serve as a different grid that forms flow guide structure on the reversed shield section 13 by having the bars 12 extending on and across the shield section so that portions of the bars 12 get raised above the shield section 13. The spaced raised portions of the bars 12 forms grooves therebetween to serve as a flow guide structure and also to prevent the foodstuff positioned thereon from directly contacting shield section 13.

Use in this way still allows the shield section 13 to provide a shielding function and also provides a flow guiding function with the grooves defined between the raised portions of the bars 12 on the shield section 13, whereby liquid substances, such as grease and juice of the grilled foodstuff and sauce applied to the food, are constrained to drain off only through the openings 121 between the bars 12 and not dropping on the burner unit 92 to cause flaming or smoke. Further, since no protection shade is arranged between the burner unit 92 and the cooking grid 10, the burner unit 92 may emit thermal energy that is directly applied to the cooking grid 10 to thereby provide functions of health, environmental protection, and energy conservation.

As shown, the raised rims 131 that face downward in this case may be helpful in conducting liquid substances, such as grease and juice of the grilled foodstuff and sauce applied to the food, to drop downward without flowing in a transverse direction due to being positioned on an uneven surface.

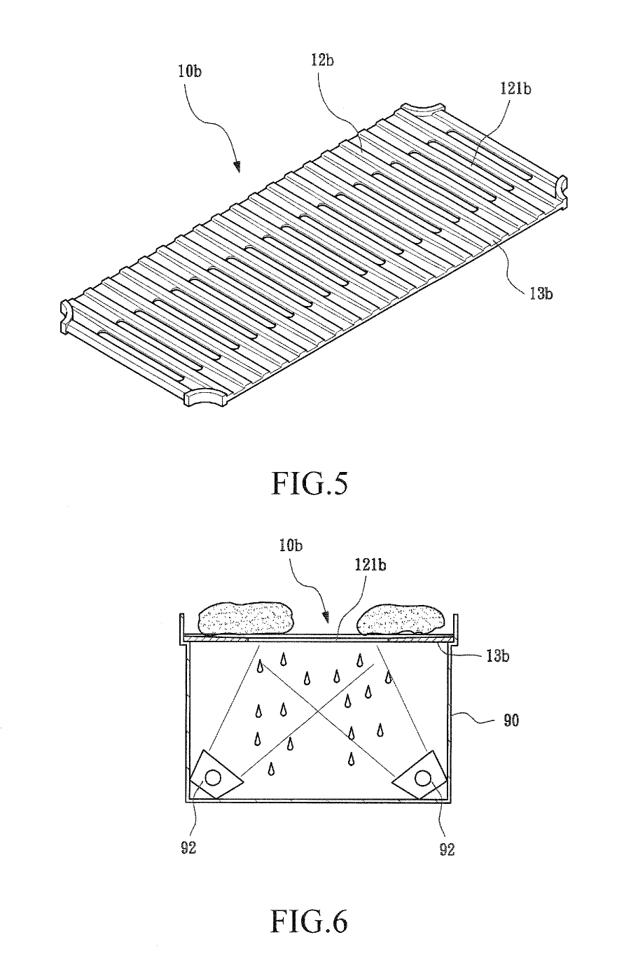

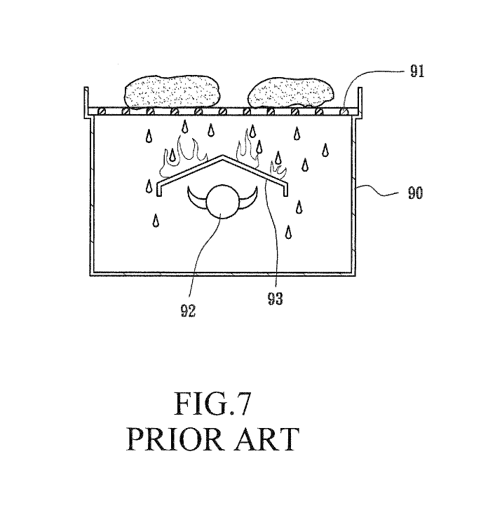

Referring to FIGS. 5 and 6, a cooking grid according to another embodiment of the present invention is shown, which is applicable to the situation where burner units 92 are arranged on opposite sides of a grill 90. In such a situation, shield sections 13b are arranged to correspond in position to the burner units 92 and are thus located on two opposite side portions of the cooking grid 10b with a central portion of the cooking grid 10b being hollow and bars 12b extending across the hollow portion and defining openings 121b therebetween.

With such an arrangement, the same function of shielding can be achieved with the shield sections 13b, and also, portions of the bars 12 that extend on the shield section 13b form grooves therebetween to provide a function of flow guiding, which allows liquid substances, such as grease and juice of the grilled foodstuff and sauce applied to the food, to drain off only through the openings 121b between the bars 12b and not dropping on the burner units 92 to cause flaming or smoke. Since no protection shade is arranged between the burner units 92 and the cooking grid 10b, the burner units 92 may emit thermal energy that is directly applied to the cooking grid 10b to thereby provide functions of health, environmental protection, and energy conservation.

In summary, according to the present invention, the cooking grid is integrated with a burner protection shade of a grill as a unitary structure, so that in grilling food, a true smoke-free grilling operation can be realized. Further, the protection shade of the grill can be eliminated, which help simplifying the structure and reducing the manufacturing costs of a grill. Apparently, unique efficacies are provided.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A cooking grid, which is adapted to be positioned on a top opening of a grill, the grid comprising a frame, a plurality of bars, and a shield section, wherein the bars and the shield section are arranged inside the frame, the bars forming therebetween a plurality of openings, the shield section being arranged to correspond in position to a burner unit set up inside the grill, whereby when the cooking grid receives foodstuffs positioned thereon for grilling, the shield section provides a shielding function that prevents liquid substances of grease and juice of the grilled foodstuffs and sauce applied to the foods from dropping on the burner unit to cause flaming and smoke, and thermal energy emitting from the burner unit is directly applied to the cooking grid to thereby provide functions of health, environmental protection, and energy conservation.

2. The cooking grid according to claim 1, wherein the shield section is arranged at a central portion of the cooking grid.

3. The cooking grid according to claim 1, wherein the shield section is arranged at one side portion of the cooking grid.

4. The cooking grid according to claim 1, wherein the shield section has a circumference on which a plurality of raised rims is formed, the raised rims of the shield section delimit and define a recessed chamber therebetween and the raised rims form therebetween a plurality of notches.

5. The cooking grid according to claim 1, wherein the shield section comprises a flat surface.

6. The cooking grid according to claim 1, wherein the bars extend on the shield section to have portions of the bars raised above the shield section.
